(19) United States
(12) Patent Application Publication
(10) Pub. No.: US 2005/0066342 A1
(43) Pub. Date: Mar. 24, 2005

(54) OPTICAL DISC DRIVE WHICH CAN FIRMLY FIX THE TRAY WITHIN THE HOUSING

(76) Inventor: Chin-Fa Tu, Taipei City (TW)

Correspondence Address: (NAIPC) NORTH AMERICA INTERNATIONAL PATENT OFFICE, P.O. BOX 506, MERRIFIELD, VA, 22116, US

(21) Appl. No.: 10/707,681

(22) Filed: Jan. 4, 2004

(30) Foreign Application Priority Data
Sep. 24, 2003 (TW) 092126410

(51) Int. Cl. G11B 17/04; G11B 17/03; G11B 33/02

(52) U.S. Cl. 720/610

(57) ABSTRACT

An optical disc drive includes a housing with two tracks, a tray able to slide along the two tracks installed inside the housing, a solenoid fixed on the tray for providing magnetic force, a latch installed beside the solenoid for generating movements according to changes in the magnetic force, a push pod fixed on the tray with one end connected to the latch, an elastic device set on the tray for pushing the pushing pod elastically, a positioning shaft fixed on the housing, and a hook having a first end fixed on the tray, a second end positioned next to the push rod, and the third end for engaging the positioning shaft.

### BACKGROUND OF INVENTION

1. Field of the Invention

The present invention relates to an optical disc drive, and more specifically, to an optical disc drive that can stably fix the tray module within the housing.

2. Description of the Prior Art

In general, the tray-in and tray-out modules of the tray module in a thin optical disc drive are operated by a dc motor or suction solenoid. Usually, the method used by the dc motor collocates the gear module with either the light sensor or the limitation switch. The dc motor mechanism is quite complete, so the cost cannot be reduced.

In the method used by a suction solenoid, the volume of the suction solenoid mechanism is quite large. A consequence of the large size is that a suction solenoid mechanism may not be employed in an optical disc drive due to limited space in the optical disc drive unless drastic changes are made to the appearance of the product. Additionally, when the suction solenoid is not supplied with the power, the elasticity of the spring on the solenoid does not easily hold the tray-in module in a stable position. The following describes an optical disc drive that uses a suction solenoid.

Please refer FIG. 1-FIG. 5. FIG. 1 is a schematic diagram of the tray module 14 of the optical disc drive 10 that is in the tray-in location. FIG. 2 is a schematic diagram of the tray module 14 of the optical disc drive 10 that is in the tray-out location. FIG. 3 is a schematic diagram of the tray-out module 15 of the optical disc drive 10 in FIG. 1. FIG. 4 is a location diagram of each component when the tray module 14 of the optical disc drive 10 in FIG. 1 is in the tray-in location. FIG. 5 is a location diagram of the tray-in module 21 of optical disc drive 10 in FIG. 1 that is in the tray-out location.

The optical disc drive 10 comprises a housing 12, a tray module 14 comprising a tray 16, a tray-out module 15 set on the tray 16 for pushing the tray module 14 out of the housing 12 with respect to the bottom of the housing 12, and a tray-in module 21 set on the tray 16 for locking the tray module 14 within the housing. The tray-out module 15 comprises a pusher 18 movably set on the tray 16, an extension spring 20 with one end fixed on the tray 16 and the other end fixed on the pusher 18. The tray-in module 21 comprises a solenoid 22 fixed on the tray 16, a shaft 24 fixed on the front end of the solenoid 22, a solenoid spring 26 set on the shaft 24, a hook 28 set on the front end via the shaft 24, and a positioning point 29 set on the tray 16.

Please refer to FIG. 3 and FIG. 4. When the tray module 14 of the optical disc drive 10 is in the tray-in location, the extension spring 20 is compressed according to how far tray 16 is within the housing 12. During this time, the extension spring is capable of pushing the tray module 14 out of the housing 12. When the solenoid 22 is not supplied with power, the solenoid spring 26 pushes the hook 28 to lock onto the positioning point 29, thereby preventing the pusher 18 from pushing the tray module 14 out of the housing 12.

Please refer to FIG. 1, FIG. 3, and FIG. 5. The tray-out process is operated via the key 27 on the panel of the optical disc drive 10. When the key 27 is pressed, the optical disc drive 10 sends a control signal to notify the CPU; then the CPU sends another control signal to supply the solenoid 22 with power. When the solenoid is supplied with power, the solenoid 22 generates a magnetic force to attract the shaft 24. The magnetic force of solenoid 22 is larger than the thrust of the solenoid spring 26, so the hook 28 will depart from the positioning point 29. When the hook 28 departs from the positioning point 29, the pusher 18 pushes the tray module 14 15-25 mm out of the housing 12.

However, when the suction solenoid as shown in FIG. 1 is not supplied with power, the pushing force from the solenoid spring 26 is not enough to hold the tray-in module. The hook 28 and the positioning point 29 may be separated by an external force, causing the tray module 14 to come out of the housing 12.

### SUMMARY OF INVENTION

It is therefore a primary objective of the claimed invention to provide an optical disc drive that can stably fix the tray module within the housing.

The claimed invention provides an optical disc drive comprising a housing with two tracks, a tray installed along the two tracks inside the housing, a solenoid fixed on the tray for providing magnetic force, a latch installed beside the solenoid for generating movements according to changes in the magnetic force, a push rod fixed on the tray with one end connected to the latch, an elastic device installed on the tray for elastically moving the push rod, a positioning shaft fixed on the housing, and a hook having a first end fixed on the tray, a second end positioned next to the push rod, and a third end for engaging with the positioning shaft.

Accordingly the properties of the solenoid is used in the invention, along with the push rod, hook, and the tray-out module, to stably fix the tray module of the optical disc drive in the tray-in location and to solve the problem in the prior art of the tray module not being stably fixed within the housing. The components are not highly dependent, so the precision of the components is not necessarily high. As a result, assembling inaccuracy can be reduced so that quality and cost can be improved. Therefore, an optical disc drive of the invention is a simple-mechanism with stable operation and artistic design.

### BRIEF DESCRIPTION OF DRAWINGS

FIG. 1 is a schematic diagram of a tray module of an optical disc drive that is in the tray-in location according to the prior art.

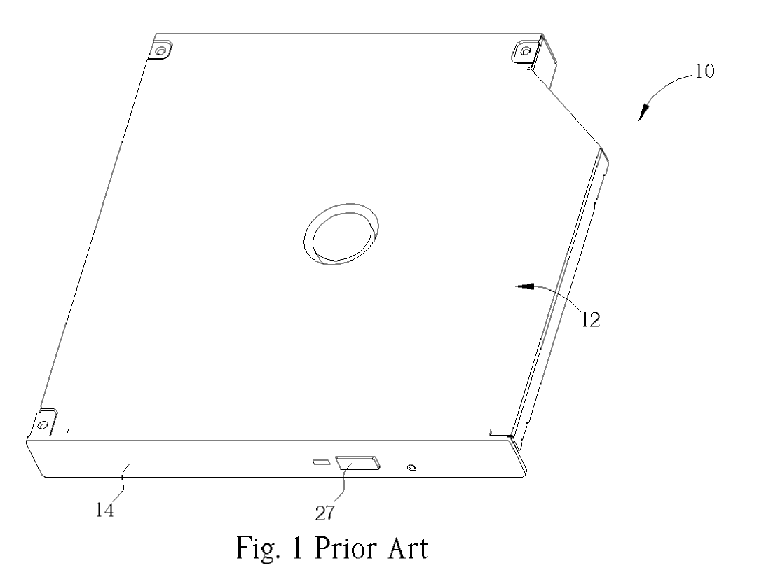

FIG. 2 is a schematic diagram of the tray module of the optical disc drive in FIG. 1 that is withdrawn completely out in the tray-out location.

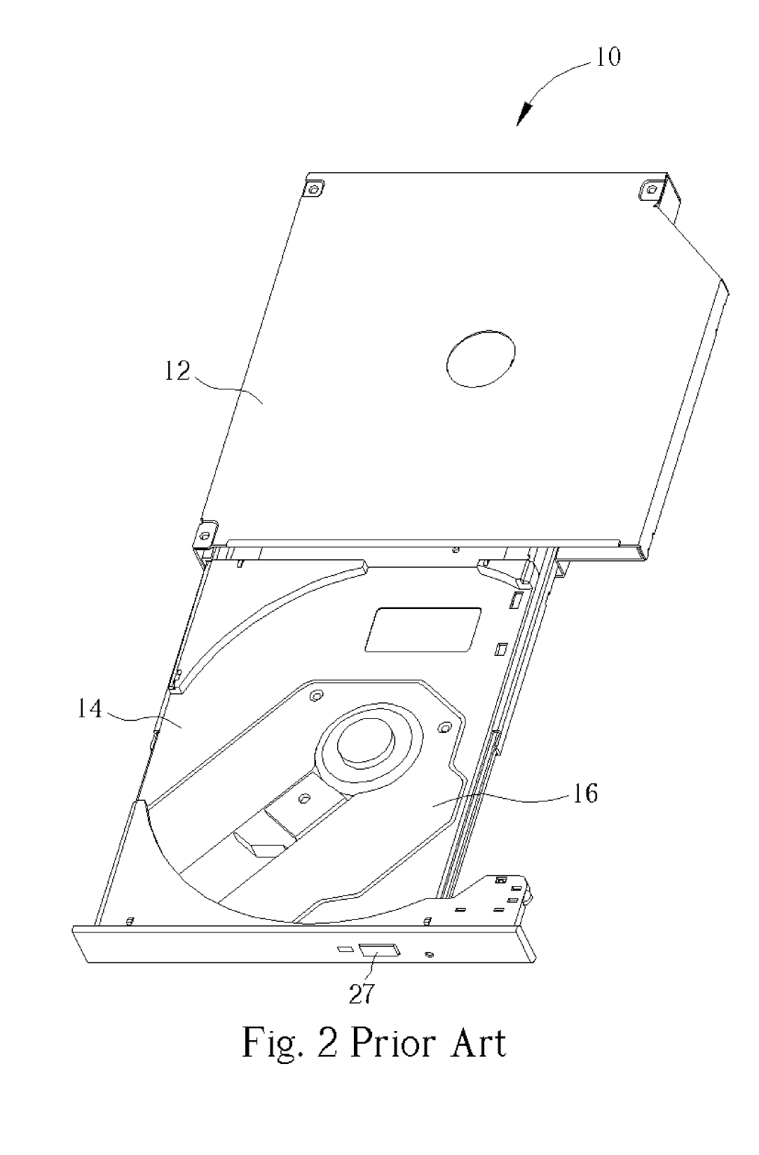

FIG. 3 is a schematic diagram of the tray-out module of the optical disc drive in FIG. 1.

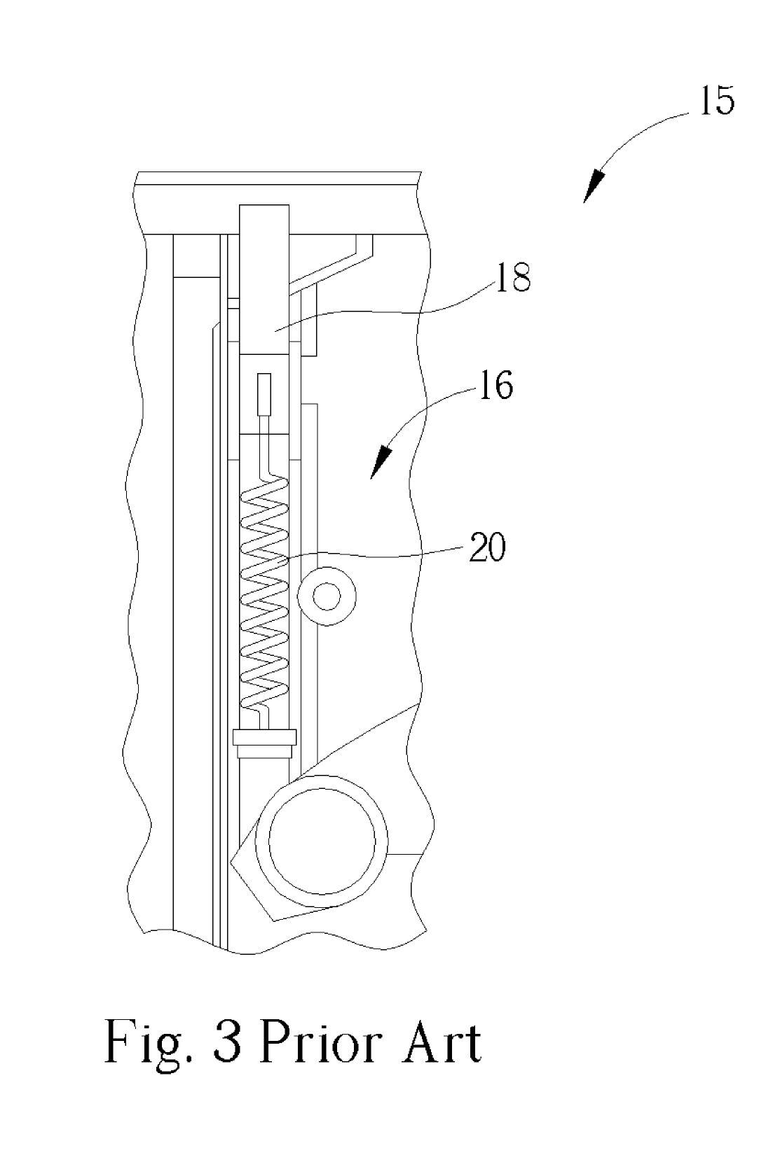

FIG. 4 is a location diagram of each component when the tray module of the optical disc drive in FIG. 1 is in the tray-in location.

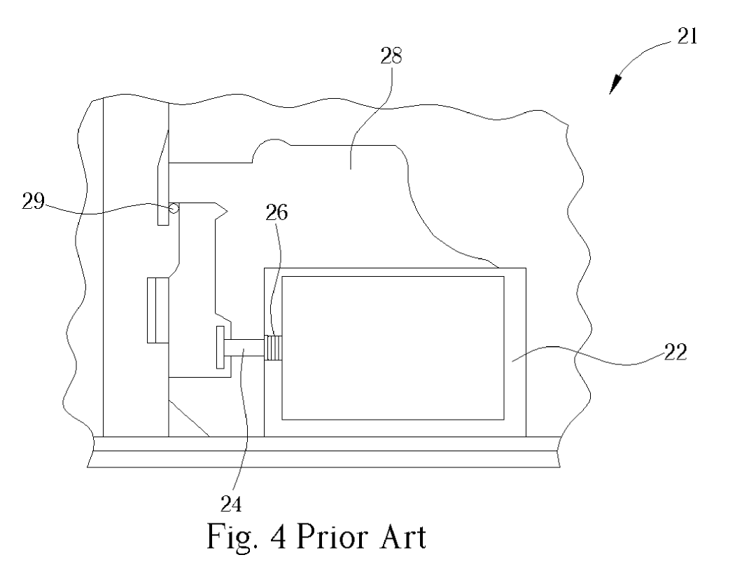

FIG. 5 is a location diagram of each component when the tray module of the optical disc drive in FIG. 1 is in the tray-out location.

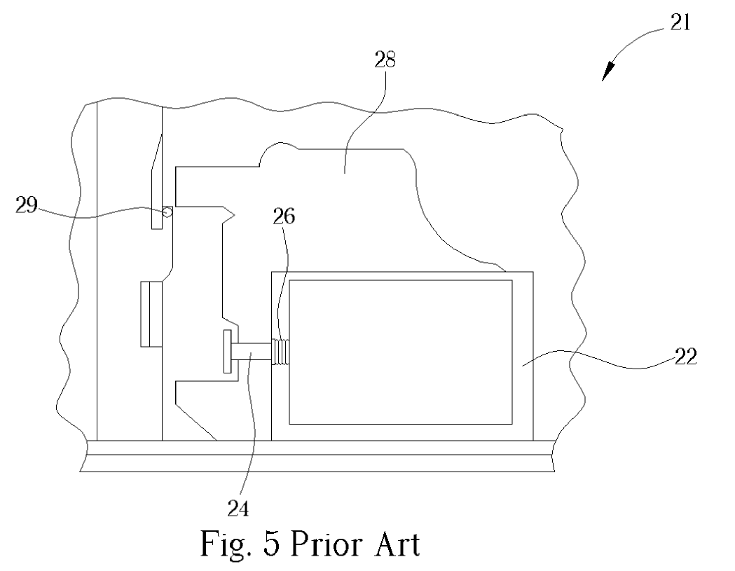

FIG. 6 is a schematic diagram of a tray module of an optical disc drive that is in the tray-in location according to the invention.

FIG. 7 is a schematic diagram of a tray module of the optical disc drive in FIG. 6 that is withdrawn completely out in the complete tray-out location.

FIG. 8 is a full view of all components in the optical disc drive in FIG. 6.

FIG. 9 is a reverse view of some components when the tray module of the optical disc drive in FIG. 8 is in the tray-out location.

FIG. 10 is a schematic diagram of an elastic device in FIG. 8

FIG. 11 is a schematic diagram of a solenoid and a latch of the optical disc drive in FIG. 8.

FIG. 12 is a reverse view location diagram of some components when the tray module of the optical disc drive in FIG. 8 is in the tray-in location.

FIG. 13 is a location diagram of some components when the tray module of the optical disc drive in FIG. 8 is in the instant tray-out location.

FIG. 14 is a location diagram of some components when the tray module of the optical disc drive in FIG. 8 is in the complete tray-out location.

### DETAILED DESCRIPTION

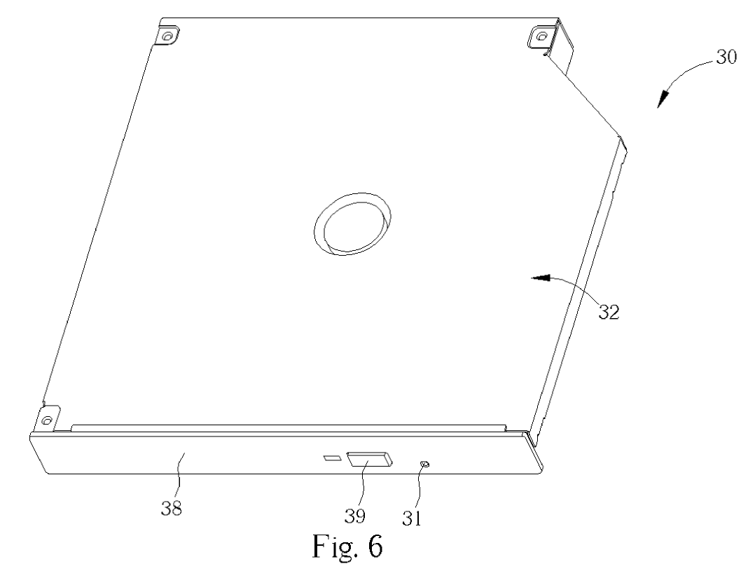

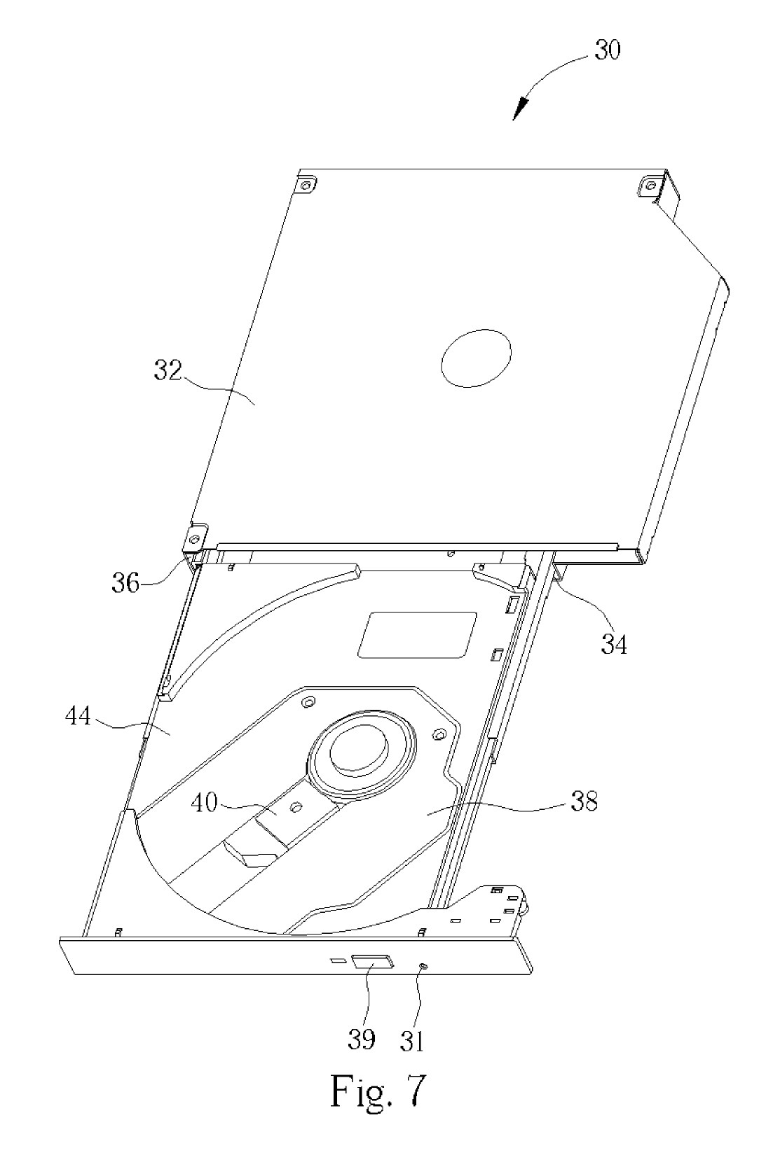

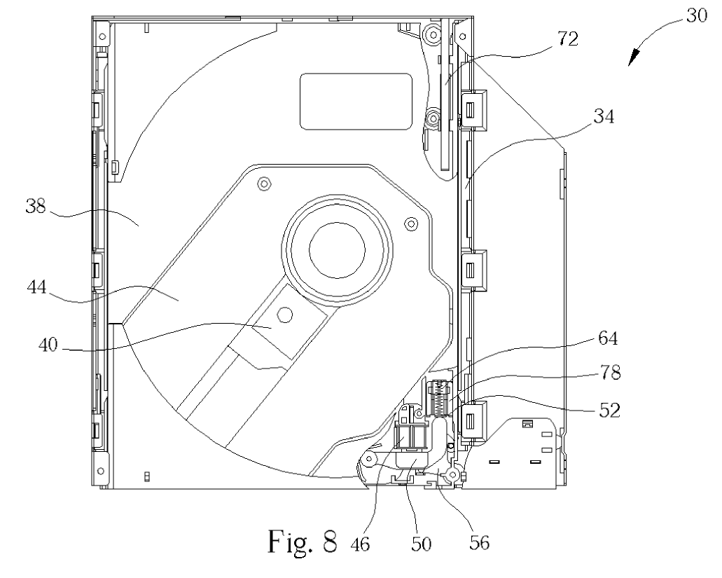

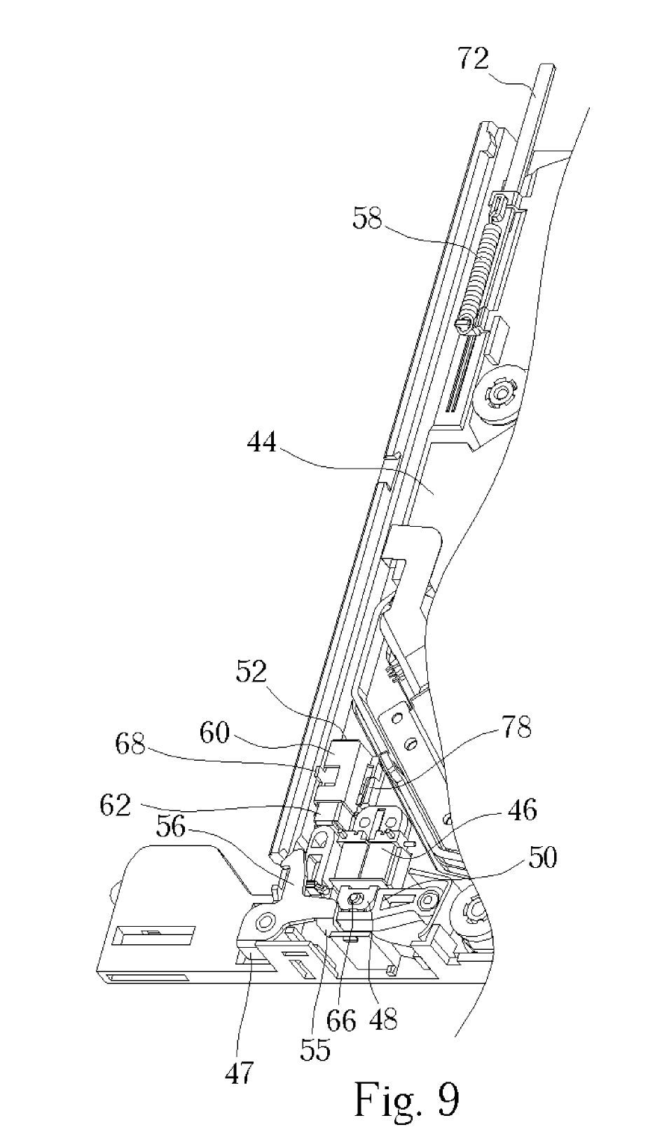

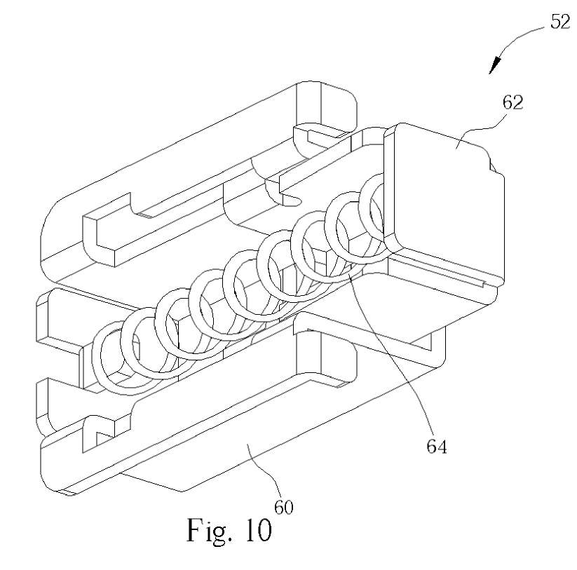

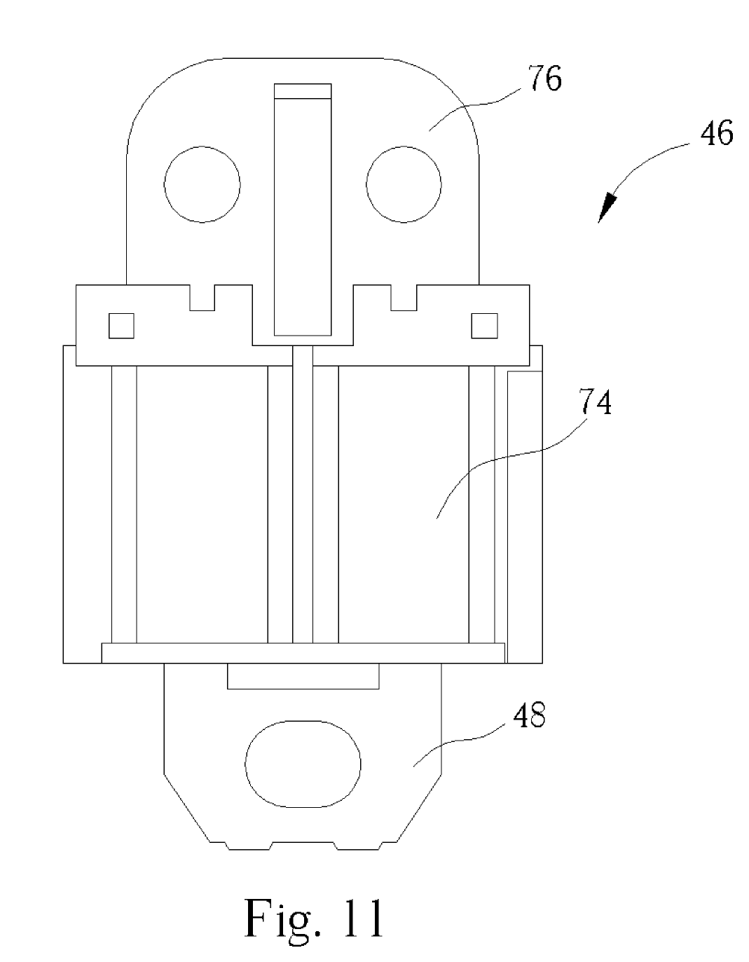

Please refer to FIG. 6-FIG. 11. FIG. 6 is a schematic diagram of a tray module 38 of an optical disc drive 30 that is in the tray-in location according to the present invention. FIG. 7 is a schematic diagram of a tray module 38 of the optical disc drive 30 in FIG. 6 that is withdrawn completely in the tray-out location. FIG. 8 is a full view of all components in the optical disc drive 30. FIG. 9 is a reverse diagram of some components when the tray module 38 of the optical disc drive 30 is in the tray-out location. FIG. 10 is a schematic diagram of an elastic device 52 in FIG. 8. FIG. 11 is a schematic diagram of a solenoid 46 and a latch 48 of the optical disc drive 30 in FIG. 8.

The optical disc drive 30 comprises a housing 32 having two tracks 34 and 36 and a tray module 38 movably installed in housing 32. The tray module 38 comprises a read/write module 40 for reading and writing the data in an optical disc, a tray 44 movably installed within the housing 32 along the tracks 34 and 36, a solenoid 46 comprising a coil 74 and a magnet 76 fixed on the tray 44 for providing a magnetic force, a latch 48 installed beside the solenoid 46 moving in accordance with the magnetic force of the solenoid 46, and an L-shaped push rod 50 installed on the tray 44. One end of the push rod 50 is connected to the latch 48 and installed on tray 44 with the ability to rotate. The push rod 50 comprises a protruding shaft 66 connected to the hole of the latch 48 for linking the latch 48.

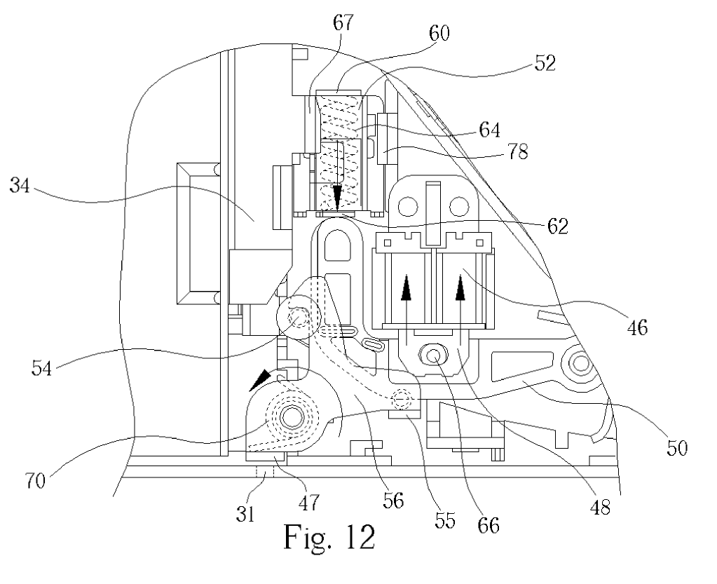

Please refer FIG. 12. FIG. 12 is a location diagram of some components in the tray module 38 of the optical disc drive 30 that is in the tray-in location. The tray module 38 further comprises a positioning shaft 54 riveted on the housing 32, a hook 56 having a first end fixed on the tray 44, a second end with an edge 55 touching the push rod 50, and the third end having a tongue-shaped extension part for engaging the positioning shaft 54 to fix the tray 44, a torsion spring 70 installed on the hook 56 for returning the hook 56 to its original position via a twisting force whenever the hook is moved by a small angle, a pushing stick 72 (displayed in FIG. 9) movably installed on the tray 44, and a extension spring 58 (also displayed in FIG. 9) with one end connected to one end of pushing stick 72 and the other end connected to the tray 44 for providing force to push the tray module 38.

Please refer to FIG. 9 and FIG. 10 again. The tray module 38 further comprises a elastic device 52 installed on the tray 44 for moving the push rod 50. The elastic device comprises an external sliding part 60 installed on the track 78 of the tray 44 in a sliding manner, an internal sliding part 62 being disposed within the external sliding part 60 and a compression spring 64 connected to the external sliding part 60 and the internal sliding part 62. The external sliding part 60 comprises a protrusion for contacting an extended part 67 (shown in FIG. 12) of the track 34 to prevent the external sliding part 60 from moving excessively when the push rod 50 is pushed against the elastic device 52.

Please refer to FIG. 6, FIG. 9, FIG. 11, and FIG. 12 again. These figures are the diagrams of each component of the optical disc drive 30 when the tray 44 is within the housing 32. The operation of tray-out is operated via pressing a key 39 on the panel of the optical disc drive 30. When the key 39 is pressed, the optical disc drive 30 sends a control signal to notify the CPU. The CPU sends another control signal to supply the solenoid 46 with power. When the coil 74 is supplied with the power, the coil 74 of the solenoid 46 generates a magnetic force to counteract the magnetic force of the magnet 76. With the force from the magnet 76 countered, the elastic device 52 moves the push rod 50, which in turn causes the latch 48 to depart from the solenoid 46 via the protruding shaft 66. The push rod 50 also moves the second end of the hook 56 to make the third end of the hook rotate and depart from the positioning shaft 54.

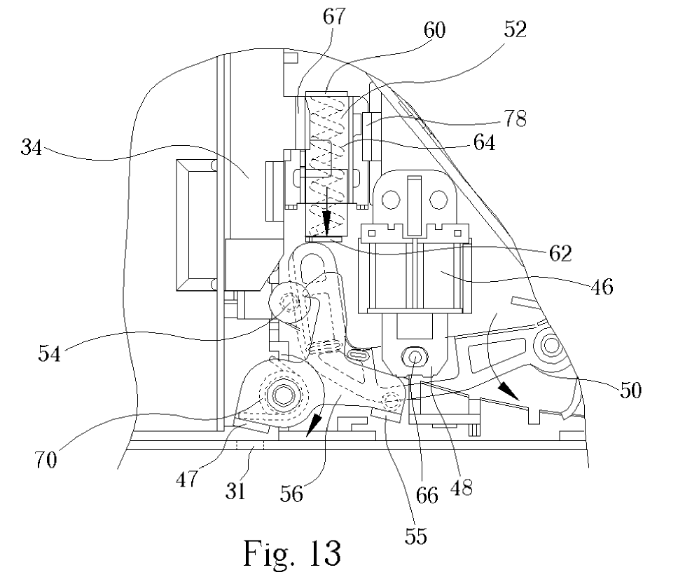

Please refer to FIG. 9, FIG. 11, and FIG. 13. These figures are diagrams of each component of the optical disc drive 30 when the tray 44 is out of the housing 32. FIG. 13 is a location diagram of some components when the tray module 38 of the optical disc drive 30 is at the tray-out location. When the solenoid 46 is supplied with power, the coil 74 of the solenoid 46 is supplied with power to generate a magnetic force to counteract the magnetic force of the magnet 76. At that moment, the force of the extension spring of the elastic device 52 is larger than the magnetic force of the solenoid 46, so the elastic device moves the push rod 50 moving the latch 48 away from the solenoid 46 by means of the protruding shaft 66. The push rod 50 moves the hook 56 by a small angle via touching the edge of the second end of the hook 56. The third end of the hook 56 will rotate and depart form the positioning shaft 54. Because the third end of the hook 56 is has departed away from the positioning shaft 54 and thus, no longer locked onto the positioning shaft 54, the tray module 38 is pushed by the extension spring 58 out of the housing 15-25 mm.

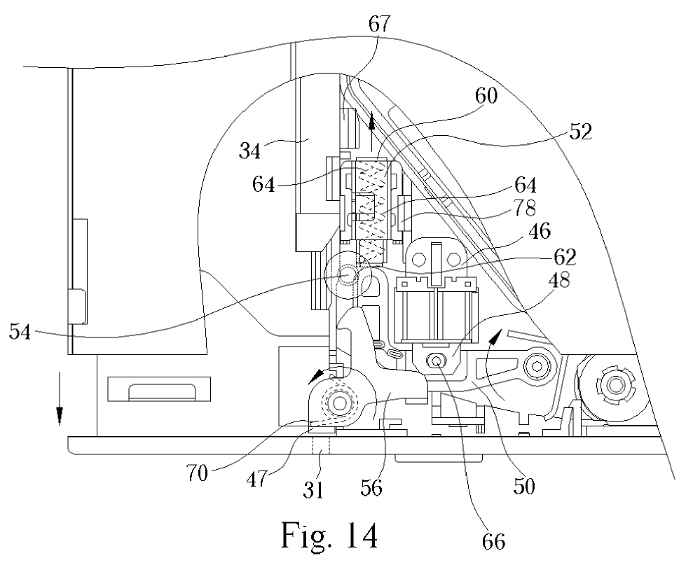

Please refer to FIG. 9, FIG. 11, and FIG. 14. FIG. 14 is a location diagram of some components of the tray module 38 of the optical disc drive 30 when the tray module 38 is withdrawn completely into the tray-out location. When the tray module 38 is pushed within the housing 32 from the tray-out location, the solenoid is not supplied with power, and the magnet 76 of the solenoid 46 attracts the latch 48 thereby fixing the push rod 50. When the tray module 38 is pushed in a distance, the protruding part 68 of the external sliding part 60 in the elastic device 52 touches the extended part 67 of the track 34 to prevent the external sliding part 60 from sliding excessively. The internal sliding part 62 is continuously pushed by the push rod 50. The compressing spring 64 within the external sliding part 60 and the internal sliding part 62 is compressed to push the push rod 50 (during this time, the pushing force is not large enough to counteract the magnetic force of solenoid so as to push the push rod 50 down.). When the tray module 38 is pushed within the housing 32 and the tongue-shaped part on the third end of the hook 56 is engaging the positioning shaft 54, the third end of the hook is moved by the positioning shaft 54 by a small angle until the tongue-shaped part of the third end of the hook has locked onto the positioning shaft 54. Locking onto the positioning shaft 54 counteracts the pushing force of the extension spring 58 when the tray module 38 is in the tray-in location.

Please refer to FIG. 6, FIG. 8, FIG. 11, and FIG. 13. The manual tray-out operation of the tray module 38 is via a needle-shaped object put in the hole 31 on the panel of the optical disc drive 30. In the manual mode, the solenoid 46 is not supplied with power. As a result, the solenoid attracts the latch 48 making the push rod 50 fixed. When a needle-shaped object pushes the edge 47 of the first end of the hook 56 via the hole 31, the first end of the hook 56 is moved by a small angle. Moving the first end causes the third end of the hook 56 to depart from the positioning shaft 54. With the hook 56 no longer locked onto the positioning shaft 54, there is nothing to counteract the pushing force of the extension spring 58 when the tray module 38 is in the tray-in location. The final result is that the tray module 38 is pushed by the extension spring out of the housing 32 15-25 mm.

Compared to the prior art, the character of a solenoid along with a push rod, hook, and tray-out module is used in an optical disc drive 30 in the invention to stably fix the tray module 38 of the optical disc drive 30 in the tray-in location and to solve the problem in the prior art i.e. the tray module 14 is not stably fixed within the housing 12. Because the components in the invention are not highly dependent, the precisions of the components are not necessarily high. As a result, the assembling inaccuracy can be reduced so that quality and cost can be improved. Therefore, the optical disc drive of the invention is a simple-mechanism with stable-operation and artistic design.

Those skilled in the art will readily observe that numerous modifications and alterations of the device may be made while retaining the teachings of the invention. Accordingly, the above disclosure should be constructed as limited only by the metes and bounds of the appended claims.

1. An optical disc drive comprising:
a housing having two tracks;
a tray installed inside the housing along the two tracks;
a solenoid fixed on the tray for providing magnetic force;
a latch installed beside the solenoid for moving according to changes of the magnetic force;
a push rod fixed on the tray with one end connected to the latch;
an elastic device installed on the tray for elastically moving the push rod;
a positioning shaft fixed on the housing; and
a hook having a first end fixed on the tray, a second end positioned next to the push rod, and the third end for engaging with the positioning shaft.

2. The optical disc drive of claim 1 wherein the solenoid comprises a magnet and a coil and the solenoid is capable of attracting the latch and the latch is capable of linking with the push rod being pushed forward to the elastic device when the coil is not supplied with power; the coil is capable of generating the magnetic force to counteract the magnetic force of the magnet and the elastic device is capable of moving the push rod forward when the coil is supplied with power.

3. The optical disc drive of claim 1 further comprising a torsion spring installed on the hook for providing a twisting force to the hook to return the hook to its original position when the hook is moved by a small angle.

4. The optical disc drive of claim 1 further comprising an extension spring installed on the tray for elastically moving the tray.

5. The optical disc drive of claim 1 wherein the elastic device comprises an external sliding part installed on the tray in a sliding manner, an internal sliding part being disposed within the external sliding part.

6. The optical disc drive of claim 5 wherein the elastic device further comprises an elastomer connecting the external sliding part and the internal sliding part.

7. The optical disc drive of claim 6 wherein the elastomer is a compression spring.

8. The optical disc drive of claim 5 wherein the external sliding part comprises a protrusion for contacting an extended part of the track to prevent the external sliding part from moving excessively when the push rod is pushed against the elastic device.

9. The optical disc drive of claim 1 wherein the positioning shaft is riveted to the housing.

10. The optical disc drive of claim 1 wherein the first end of the hook has an edge, the second end of the hook has an edge touching the push rod, and the third end of the hook has a tongue-shaped extension part.

11. The optical disc drive of claim 1 wherein the hook is used for locking the positioning shaft to fix the tray.

12. The optical disc drive of claim 1 wherein the push rod is an L-shaped push rod installed on the tray in a rotatable manner, and the push rod includes a protruding shaft connecting to a hole of the latch.
